(19) United States
(12) Patent Application Publication
(10) Pub. No.: US 2005/0073756 A1
(43) Pub. Date: Apr. 7, 2005

(54) Light collimator, method, and manufacturing method

(76) Inventor: Peter D. Poulsen, Grants Pass, OR (US)

Correspondence Address: MARTIN & ASSOCIATES, LLC, P O BOX 548, CARTHAGE, MO, 64836-0548, US

(21) Appl. No.: 10/958,241

(22) Filed: Oct. 5, 2004

Related U.S. Application Data
(60) Provisional application No. 60/508,938, filed on Oct. 6, 2003.

(51) Int. Cl. F21V 5/00; G02B 27/30; G02B 5/08

(52) U.S. Cl. 359/861; 359/641

(57) ABSTRACT

A light collimator includes an array of elongated channels that have entry openings disposed towards a light source that are smaller than exit openings disposed towards an area to be illuminated. The elongated channels have relatively high specular reflectance. Due to the sloping walls of the channels from the entry openings to the corresponding exit openings, light entering the entry openings is reflected off the walls until it exits at an angle that provides substantial collimation of the light at the exit openings. Specific implementations include relatively flat structural panels and curved panels for use with a fluorescent bulb. Manufacturing methods and methods of use are also disclosed.

### RELATED APPLICATION

This patent application claims the benefit of U.S. Provisional Application No. 60/508,938 entitled “COLLIMATING SYSTEM FOR EXTENDED LIGHT SOURCES AND METHOD TO MANUFACTURE SAME AND LIKE SYSTEMS”, filed on Oct. 6, 2003, which is incorporated herein by reference.

### BACKGROUND OF THE INVENTION

1. Technical Field

This invention generally relates to the field of energy-directing structures, and more specifically relates to light-directing structures.

2. Background Art

Many light sources that are strongly non-collimated would be of better service, and have more application, if they were more collimated. Optical techniques have been developed that allow for collimating a point light source. However, many light sources are not point light sources, but instead are extended in nature. For example, the sky and fluorescent bulbs are examples of extended light sources. Extended light sources do not lend themselves to traditional optical techniques for collimating a point light source. For this reason, there exists a need to easily and inexpensively collimate an extended light source.

### DISCLOSURE OF INVENTION

According to the preferred embodiments, a light collimator includes an array of elongated channels that have entry openings disposed towards a light source that are smaller than exit openings disposed towards an area to be illuminated. The elongated channels have relatively high specular reflectance. Due to the sloping walls of the channels from the entry openings to the corresponding exit openings, light entering the entry openings is reflected off the walls of the channel until it exits the channel at an angle that provides substantial collimation of the light at the exit openings. In a first embodiment, the area of the array at the entry openings is substantially the same as the area of the array at the exit openings. In a second embodiment, the area of the array at the entry openings is substantially less than the area of the array at the exit openings. In one particular implementation of the second embodiment, the passages are curved to allow using the light collimator to collimate the light from a fluorescent bulb. Panels that can be used as structural panels also may be fabricated with the collimator. In a preferred method in accordance with the preferred embodiments, an array of openings may be made using thin sheets of curable material. The thin, flexible sheets of material are arranged in a desired configuration, and are then exposed to a curing process, which causes the flexible sheets of material to become rigid. A method for collimating light in accordance with the preferred embodiments allows cutting a panel of the passages to a desired size and positioning the panel with its entry openings disposed towards a light source and its exit openings disposed towards an area to be illuminated.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a figure that illustrates reflection of light in a passage that has parallel walls;

FIG. 2 is a figure that illustrates reflection of light in a passage that has outwardly-sloping walls, thereby achieving a degree of collimation of the light;

FIG. 3 is a cross-sectional view showing a configuration for collimator channels in accordance with a first embodiment;

FIG. 4 is a cross-sectional view showing a configuration for collimator channels in accordance with a second embodiment;

FIG. 5 is longitudinal end view of a collimator with curved passages for a fluorescent bulb in accordance with the second embodiment;

FIG. 6 is a perspective view of the collimator shown in FIG. 5;

FIG. 7 is a cross-sectional view of an elongated channel of solid material with a full reflector layer in accordance with the preferred embodiments;

FIG. 8 is a cross-sectional view of an elongated channel of solid material with a partial reflector layer in accordance with the preferred embodiments;

FIG. 9 is a side view showing light from a light source entering the channels at different angles;

FIG. 10 is a side view of the same configuration in FIG. 9 with the addition of bridge material between the light source and the collimator;

FIG. 11 is a chart showing relative intensity of light as a function of angle off axis for a collimator in accordance with the preferred embodiments, for two known light fixtures, and for a cosine curve;

FIG. 12 is a chart showing the integral of the chart in FIG. 1, which indicates energy level as a function of angle off axis;

FIG. 13 is a side view showing use of the collimator of the preferred embodiments as a skylight or atrium panel with the sun at a first angle;

FIG. 14 is the side view in FIG. 13 with the sun at a second angle;

FIG. 15 is a side view illustrating how the elongated channels of the preferred embodiments do not allow light that is farther off axis that the collimated light to be transmitted from the exit opening to the entry opening of the channel;

FIG. 16 is a side view of a panel of collimator channels in accordance with the preferred embodiments;

FIG. 17 is a side view of the panel of collimator channels in FIG. 16 with the addition of cladding on one side;

FIG. 18 is a side view of the panel of collimator channels in FIG. 16 with the addition of cladding on both sides;

FIG. 19 is a method in accordance with the preferred embodiments for manufacturing the collimator;

FIG. 20 is a more specific method in accordance with the method in FIG. 19 for manufacturing the collimator; and

FIG. 21 is a method for collimating light from an extended light source in accordance with the preferred embodiments.

### BEST MODE FOR CARRYING OUT THE INVENTION

The preferred embodiments provide a simple and inexpensive way to collimate an extended light source. An array of elongated channels have entry openings disposed towards a light source that are smaller than exit openings disposed towards an area to be illuminated. Due to the sloping walls of the channels from the entry openings to the corresponding exit openings, light entering the entry openings is reflected off the walls of the channels until it exits at an angle that provides substantial collimation of the light at the exit openings. As used herein, the term “light” means electromagnetic waves from the ultraviolet through the near-infrared realm.

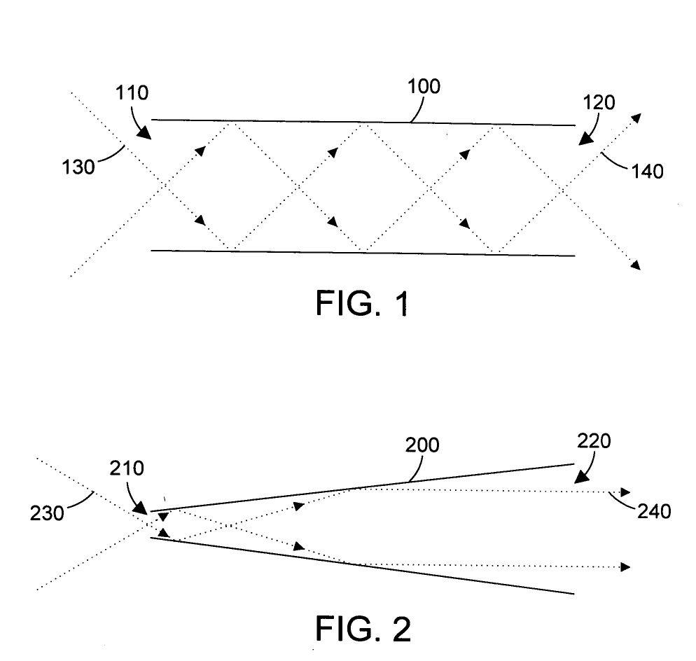

Referring to FIG. 1, an elongated reflective channel 100 is shown with parallel walls. Channel 100 has an entry opening 110 where light enters the channel and an exit opening 120 where light exits the channel. The reflection of light 130 entering the channel 100 will exit 140 the channel 100 at the same angle, relative to the channel axis, as the angle at which it entered the channel.

FIG. 2 shows an elongated reflective channel 200 in accordance with the preferred embodiments that has sloped side walls that result from the entry opening 210 being smaller than the exit opening 220. With this arrangement, the distance between the walls of the channel 200 increase (either uniformly or non-uniformly) as they move toward the exit opening 220. The result is that light 230 that enters the entry opening will reflect off the sloped walls of the channel 200, and will exit 240 at an angle closer to the channel's axis than when it entered the channel 200. The degree to which the angle of light is reduced depends upon the angles of the walls it encounters and the number of reflections that occur. For the discussion herein, the term “collimation” of light means a substantial narrowing of the angular directability of light from a light source, especially an extended light source. Note that elongated channel 200 is reflective, which means that its interior has a substantial specular reflectance. The interior portion of elongated channel 200 has a reflectance of at least 50%, preferably has a reflectance of at least 85%, and most preferably has a reflectance of 95%. In addition, the specularity of the reflectance may be specified according to a cone angle of the light reflected off the interior surface in terms of a percentage of the specular reflected component. Thus, the cone angle of specularity at 80% of the specular reflected light component is mo more than 45 degrees, is preferably no more than 10 degrees, and is most preferably no more than 5 degrees. As used in the remainder of this specification and claims herein, an elongated reflective channel is an elongated channel that has at least 50% reflectance, with a cone angle of specularity of no more than 45 degrees containing at least 80% of the specular reflected light component.

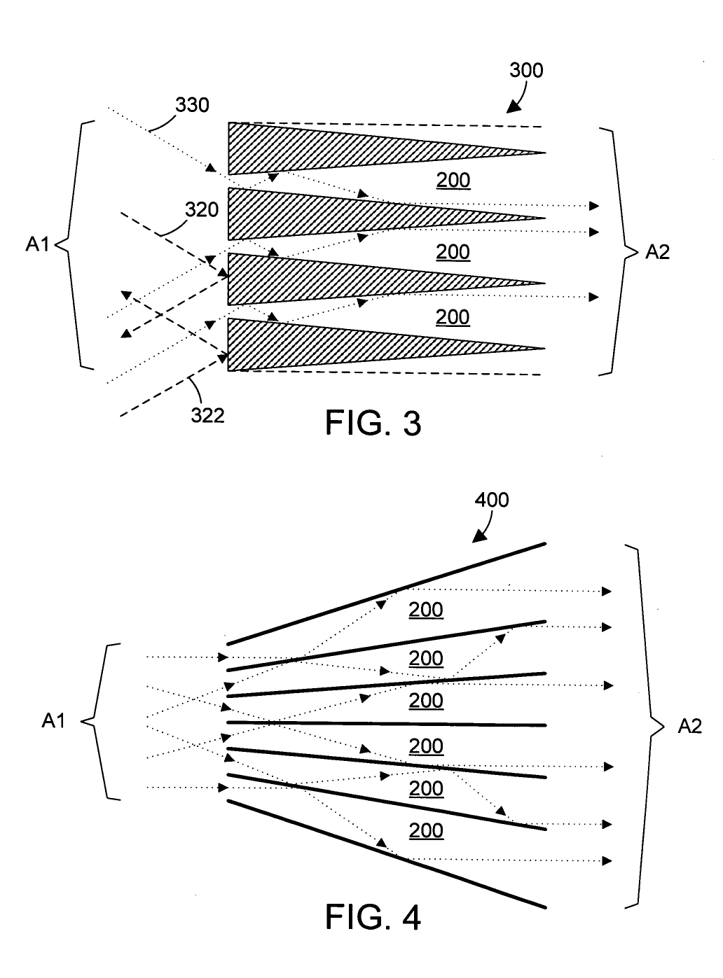

A side cross-sectional view of a light collimator 300 in accordance with a first embodiment is shown in FIG. 3, and includes an array of elongated channels 200 that have slopes sides (i.e., that have an exit opening larger than the entry opening). In this configuration, the area A1 associated with the entry openings of the channels is equal to the area A2 associated with the exit openings of the channels. While this configuration produces good collimation, the light throughput efficiency may be lowered by the blockage of the light where it cannot enter the channels of the collimating array. This is shown by light 320 and 322 in FIG. 3, which does not enter a channel, but instead reflects off of the entry portion of the array. To improve the throughput situation, the entry portion of the array can be made highly reflective, and reflectors may be placed around the light source. In this manner, the light not entering any of the channels on its first encounter with the entry side of the array can bounce around with only a modest loss of strength until it finds a channel to enter, as illustrated by light 330 in FIG. 3. Note that the angle of light 330 entering the channel is substantially reduced upon exiting the channel, thereby producing collimation of the light at the exit openings of the array.

A cross-sectional side view of a light collimator 400 in accordance with a second embodiment is shown in FIG. 4. In this configuration, the area A1 associated with the entry openings of the channels is substantially smaller than the area A2 associated with the exit openings of the channels. With this configuration, the channels are made of a very thin material that is appropriately formed to produce an array such as that shown in FIG. 4. Because the channel walls are very thin, substantially all of the light impinging the entry area of the array will be captured by a channel on its first strike, because the thin end walls reduce the possibility of producing single-bounce returns back out of the entry plane. By minimizing the wall thickness of the elongated channels, the amount of light that is directly reflected off the end walls of the channels is minimized. For this reason, the throughput of light through the array is substantially improved when compared to the configuration of the first embodiment shown in FIG. 3.

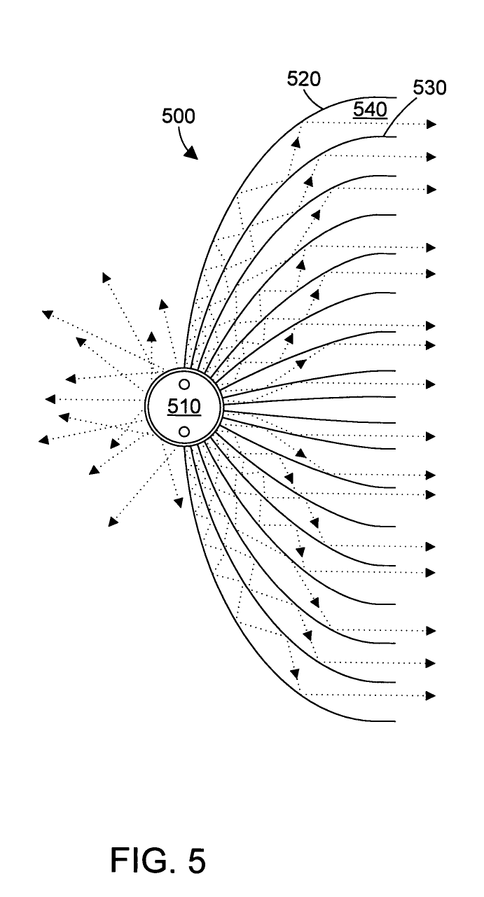

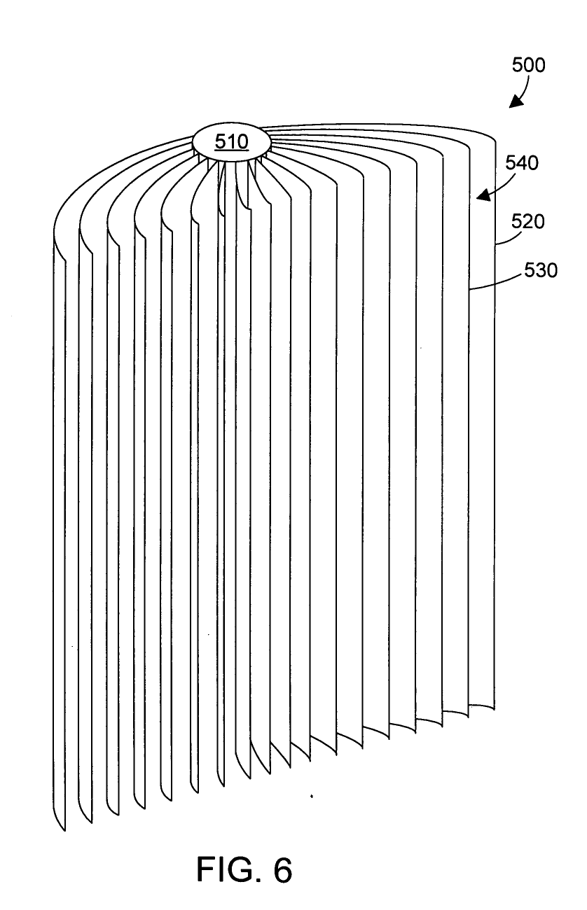

Referring now to FIGS. 5 and 6, a specific example of the light collimator in accordance with the second embodiment shown in FIG. 4 is shown as collimator 500 for the specific application of collimating a light from a fluorescent bulb. An end view of bulb 510 is shown in FIG. 5. Note that light exiting the bulb on the left side of FIG. 5 is uncollimated. Collimator 500 includes a plurality of thin members that define channels 540 that are curved and that have an exit area greater than the entry area of the channel (as explained above and shown in FIG. 4). Thus, channels 540 are one specific configuration for channel 200 in FIGS. 2-4. Members 520 and 530 jointly define a curved, elongated channel 540 that has a small entry opening disposed next to the bulb 510 and a larger exit opening disposed towards an area to be illuminated. The other members in FIG. 5 cooperate in the same manner to define the plurality of elongated, curved channels shown. The collimator 500 thus includes a curved structure of elongated channels that each have first and second openings, where each second opening for a channel is larger than the corresponding first opening for the channel, where the first openings are arranged to lie along an arc of a circle defined by a size of the fluorescent bulb, and where the second ends of the elongated channels (at the exit openings) are located in substantially the same plane. In the most preferred implementation of the fluorescent light collimator 500 shown in FIG. 5, the plane of the second ends of the elongated channels is substantially perpendicular to the shortest line between the plane and the circumference of the bulb 510. This arrangement allows for collimation of an extended light source (such as a fluorescent light bulb) using a simple, lightweight and inexpensive collimator.

The elongated channels of the preferred embodiments may have any suitable geometric configuration, including combinations of different geometries. For example, the elongated channels could be conical in shape, meaning that both entry and exit openings are both circular. The entry and exit openings could also be rectangular, square, triangular, hexagonal, or any other suitable geometric configuration. For the specific configuration shown in FIGS. 5 and 6, the entry and exit openings are both elongated rectangles with the long part of the rectangle running along the longitudinal axis of the fluorescent bulb. These different geometries are listed herein as examples of suitable shapes for the entry and exit openings that are within the scope of the preferred embodiments. However, the preferred embodiments expressly extend to any and all suitable geometric shapes and combinations that could be used to create a plurality of elongated channels that have exit openings that are substantially greater than their corresponding entry openings.

A typical fluorescent bulb is cylindrical in shape, thereby producing a straight line longitudinal axis. As a result, a collimator 500 as shown in FIGS. 5 and 6 is substantially straight along the axis of the fluorescent bulb, as shown by the members 520 and 530 in FIG. 6 running straight up and down. Note, however, that the principles of the preferred embodiments could also be used for non-linear light sources, such as neon lights that are bent in various different configurations. The collimator 500 in FIGS. 5 and 6 could be modified to follow a curved light source (such as a neon light) to effectively collimate the light emanating from the curved light source.

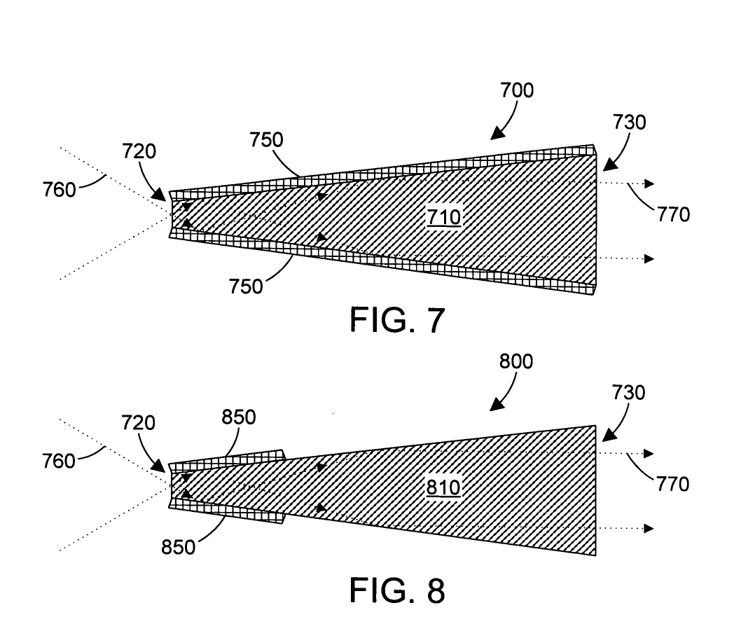

As shown in FIGS. 4-6, the preferred implementation for the second embodiment uses thin material to form the channels. Note, however, that it is also within the scope of the preferred embodiments to provide elongated channels within a solid light-transmissive material, such as plastic or glass, as shown in FIGS. 7 and 8. FIG. 7 shows an elongated channel element 700 that would be one element in an array of elements. Channel element 700 includes a channel 710 of solid material that includes an entry opening 720 and an exit opening 730. We assume for this example that the index of refraction (relative to that of adjacent material) for the material of the channel 710 does not support total internal reflection. As a result, a reflective coating 750 is applied to the walls. By applying the reflective coating, light 760 entering the entry opening 720 is substantially collimated by the time the light 770 exits the exit opening 730.

FIG. 8 shows an elongated channel element 800 that includes an elongated channel 810. We assume in this example that the channel 800 includes a reflective coating 850 that covers only part of the length of the channel 810. The rest of the channel is composed of a transparent medium, which provides continued reflection using the condition of total internal reflection. As the angle of incidence becomes more oblique inside the transparent material, the condition of total internal reflection (TIR) is reached and no external reflective coating is needed to obtain almost 100% reflection. The preferred embodiments expressly include elongated channels that have no reflective coating, that have a partial reflective coating (e.g., FIG. 8), and that have a full reflective coating (e.g., FIG. 7). The coating may be an adhered thin-film reflective coating (the result, for example, of vacuum or chemical deposition). Or the coating may be a reflective thin sheet of metal or other suitable reflective material that is in optical contact with the channels, or a suitable liquid reflective material that may be applied by any suitable technique such as spraying, sputtering, brushing, dipping, etc.

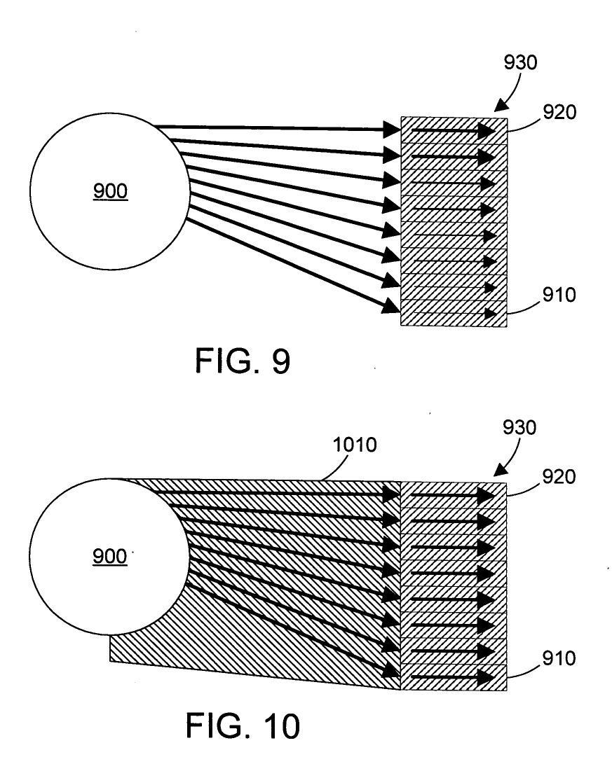

The preferred embodiments also provide the ability to further enhance the throughput efficiency of the system by matching the indices of refraction as shown in FIGS. 9 and 10. The degree of reflection at each interface between air and material, as well as at interfaces between differing materials, increases both with the amount of difference between their indices of refraction and with the obliqueness of the angle at which the light is incident to the surface normal. Thus, for array 930, less light will enter the bottom channel 910, the remainder being reflected away, then will enter channel 920. Therefore, less intensity will exit channel 910 than will exit the top channel 920 due to the higher angle of incidence for the light entering the bottom channel 910. This is shown graphically in FIG. 9 by the lower arrows being lighter than the upper arrows. This decrease in throughput efficiency shown in FIG. 9 may be alleviated to a large degree using a “bridge” 1010 that is interposed between the light source 900 and the array 930 as shown in FIG. 10. The material of bridge 1010 is selected to keep a continuity of matched indices of refraction, the bridge material 1010 index of refraction being preferably between that of the light source 900 and the material of collimator 930. Alternatively, or in addition to which, a change of indices can be made more gradual than what is inherent to the materials. These techniques reduce interface reflection and can be of major significance at oblique angles, where the reflection coefficients increase dramatically. The improvement in light intensity is shown graphically in FIG. 10 by the arrows having the same appearance in all channels.

An immediately notable feature of the preferred embodiments is their ability to focus the majority of light emitted from an extended light source into an angular distribution much smaller than would otherwise result from such a source. Beneficial applications of this feature can be realized in fluorescent lamp fixtures, atrium skylights, alley skylights, flash detectors, etc.

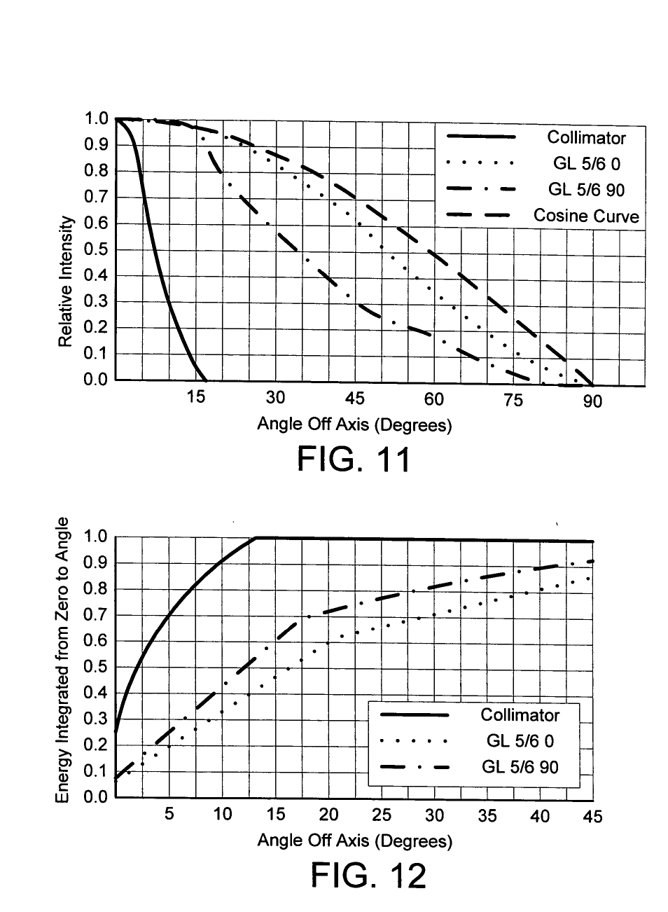

An example benefit of the collimator of the preferred embodiments for fluorescent light fixtures can be illustrated by considering the illumination of an area of floor by a ceiling-mounted fluorescent light with and without the addition of the collimator. Looking at test data for a known commercial lighting fixture, such as catalog item #GL-4-654T5H-EB2/2/120 available from H. E. Williams, Inc. at PO Box 837, Carthage, Mo. 64836-0837, we can construct the curve shown in FIG. 11. This is a plot of four illumination-versus-angle curves. The two GL5/6 curves shown in FIG. 11 are for off-center angles transverse to the fluorescent tube's axis of symmetry. The cosine distribution curve in FIG. 11 illustrates the expectation if the tube were backed only with a diffuse reflective paint.

The collimator of the preferred embodiments, however, provides considerable improvement over a diffuse reflector, as shown in the performance curve for the collimator in FIG. 11. In this illustration, the collimator takes the general form of FIGS. 5 and 6, where the area of the exit openings is approximately the same as the area of light opening in the commercial fixture. In this example in FIG. 11, the configuration of the collimator has not been mathematically optimized, but has been laid out merely in accord with a generalized application of the geometrical requirements using just a single fluorescent lamp. Nevertheless, the computation of the collimator's performance shows a significant enhancement of directivity control resulting when compared to the other curves in FIG. 11. The curves in FIG. 11 clearly illustrate the ability to reduce the angular spread of the light by using the collimator of the preferred embodiments. This control is valuable in many regards. For example, when lighting of a limited area is desired without spilling excess light into its surrounding areas, the collimator of the preferred embodiments provides the same type of control for an extended light source that is only available in the prior art with point-like emitters such as incandescent filament lamps and light-emitting diodes (LEDs).

We now integrate the intensity curves in FIG. 11 to determine energy that results at various angles off axis, with the result shown in FIG. 12. For the case of five degrees off axis, we can see that the GL 5/6 0 curve has a value of approximately 0.2, while the energy of the collimator at 5 degrees off axis is approximately 0.7. This means that if a lighting engineer wants to illuminate a one foot strip on a floor with a fluorescent lamp equipped with the collimator 500 shown in FIGS. 5 and 6 mounted in the ceiling 12 feet above the floor, then the equivalent of 3.5 of the same fluorescent lamps would be needed to match the one lamp that has been equipped with a collimator 500 shown in FIGS. 5 and 6. For a two foot strip along the floor, the matching illumination would require the equivalent of 3.4 lamps. For a three foot pathway, illumination match to the single lamp with the collimator 500 would require the equivalent of 3.1 lamps using the commercial fixture. In these calculations, the efficiency of multiple reflections is taken as the same for both the collimator of the preferred embodiments and the commercial fixture. Of course, the narrow strip of illumination is applicable to uses other than pathways. Examples would include, but not be limited to, table workspaces, the fronts of book shelves, lighting of artwork, display of “sparkling” jewelry, and illumination of plant growing boxes. If turned on end, fluorescent lamps with collimator 500 could be used to illuminate vertical strips in rooms, on sides of buildings, along parking lanes, and into “space” to provide directional beams for navigational guidance. These numerical values are for a light collimator that is approximately two feet in dimension and whose end channels cant towards the center of the path. For a light at a distance of 12 feet, using the data in FIG. 12, the strip that will contain 70% of the light has a half-angle of 5 degrees. By simple trigonometry, the strip is found to be two feet wide (2*12*sin 5=2). For the same 5 degree half-angle, FIG. 12 shows that only 20% of the light without a collimator is produced. Therefore, for the same illumination level within the same two-foot strip, a total of 70/20=3.5 lights will be needed to match the illumination of the single collimated light. Using the ratios of data points in FIG. 12 at various angles can be used likewise to compute the relative efficiencies to illuminate other pathwidths.

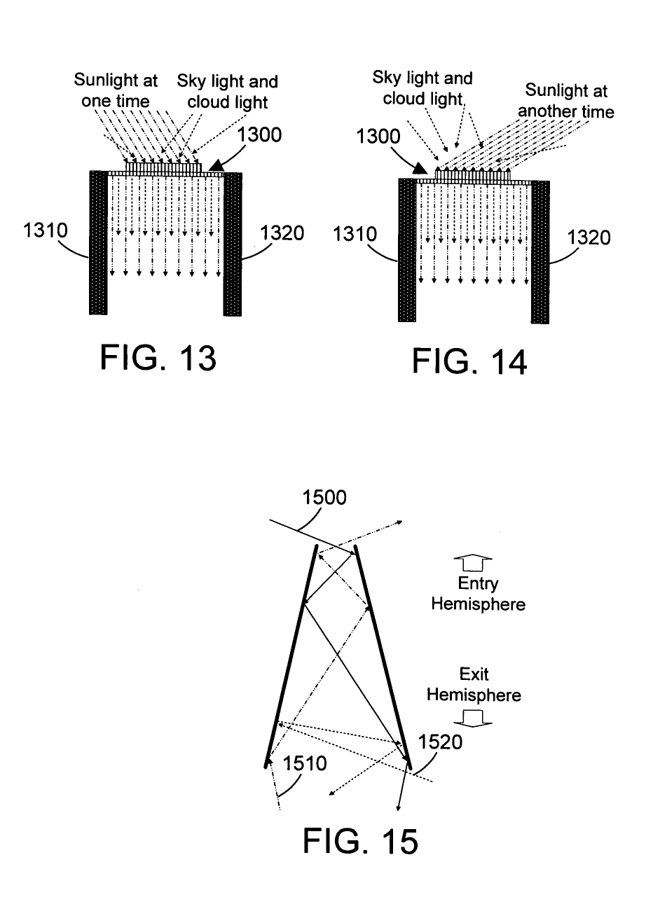

FIGS. 13 and 14 show the use of a panel in accordance with the preferred embodiments for illuminating an area that normally does not receive much direct sunlight, such as an alley or atrium between high-rise buildings in a city. In these examples, a panel 1300 in accordance with the preferred embodiments is placed between two walls 1310 and 1320. The panel 1300 has entry openings disposed towards the sky, and has exit openings disposed between the walls. Light from various sources may contact the entry openings of panel 1300. For example, sunlight may directly hit the panel from a particular angle, as shown in FIG. 13. Direct sunlight at any location on earth is highly collimated given the large distance between the sun and the earth, which means that only light in a very narrow angle (i.e., that is highly collimated) will strike the earth. Other sources of light such as light from the sky and clouds is a more extended light source, providing relatively uncollimated light to panel 1300. Note that both the collimated light from the sun and the uncollimated light from the sky and clouds is directed downward between the walls 1310 and 1320 using panel 1300. Thus, the relatively collimated light from the sun is redirected downward between the walls, while the relatively uncollimated light from the sky and clouds is collimated downward between the walls, as shown in FIG. 13.

FIG. 14 shows what happens when direct sunlight hits the panel 1300 from a different angle, while light from the sky and clouds also hits the panel 1300. Again, as in FIG. 13, both the collimated and uncollimated light sources are directed downward between the walls 1310 and 1320. This allows a relatively constant light level to be achieved between the walls as long as sunlight is striking the entry openings of the panel 1300.

Panel 1300 in FIGS. 13 and 14 is shown in a substantially flat embodiment, but with an area of exit openings that is larger than the corresponding area of entry openings. In this substantially flat configuration, the panel 1300 can be described as separating two hemispheres. The hemisphere from which the embodiment is designed to accept light is referred to as the “entry hemisphere. The complementary hemisphere to be illuminated will be referred to as the “exit hemisphere.” It should be noted, however, that the preferred embodiments do not require a planar embodiment, and that non-planar embodiments are anticipated and are included within the scope of the preferred embodiments herein.

The utility of panel 1300 for atrium and alleyway skylights recognizes the sky as a time-varying extended source. In this respect the extended source not only changes in aggregate as a source, but also changes in position and relative strength of the sky's multiple brightness components throughout the panel's entry hemisphere. The clouds and the sun itself can change brightness and position throughout a day. If the panel 1300 is placed across a clear atrium roof, or is positioned to span an alleyway, then the light from the sun, clouds, and sky can be focused downward toward the ground no matter where the sun, clouds, and sky (or indeed any other source that illuminates the panel 1300) might be positioned. The preferred embodiments allow areas that might ordinarily receive very little value of direct sunlight during even a small part of a day to enjoy the benefits of that light throughout a day.

Besides the efficiency value of the collimator of the preferred embodiments, the utility of the collimator is further realized in the fact that it keeps light from passing into areas where illumination is not desired. This utility can be exploited in theme parks, movie theaters, and other facilities where the presence of light in areas outside a desired illumination area would be distractive and/or dangerous.

An added attribute of the collimator of the preferred embodiments results from its two-way nature. That is, angles within the exit hemisphere into which the collimator will not send light impinging from the entry hemisphere has a relationship to light that impinges the collimator's exit side from the entry hemisphere. The collimator will not let light pass through it from the exit side to the entry side if that light comes from angles outside of the distribution angle provided by the channel. Instead, light entering the collimator within its exit hemisphere but from angles outside of the collimator's exit distribution angle will be reflected back into the exit hemisphere. This is illustrated in FIG. 15. Light ray 1500 impinges the elongated channel of the preferred embodiments from the entry hemisphere and traverses through the collimator into the exit hemisphere, but upon entering is now more closely aligned with the optical axis of the collimator. Light ray 1510 impinges the collimator from the exit hemisphere and from within the limits of the collimator's distribution angles. Accordingly, by virtue of the path reversibility of the collimator, light ray 1510 can traverse (but not of necessity) the channel shown in FIG. 15 and pass into the entry hemisphere. Light ray 1520 impinges the collimator from the exit hemisphere, but does so from without the limits of the collimator's distribution angles. The reflection path of light ray 1520 therefore directs light coming from angles in the category of ray 1520, via one or more reflections, back into the exit hemisphere from whence it impinged the collimator. As a positive attribute, this helps keep light within areas such as atriums and alleyways that might otherwise escape into the sky.

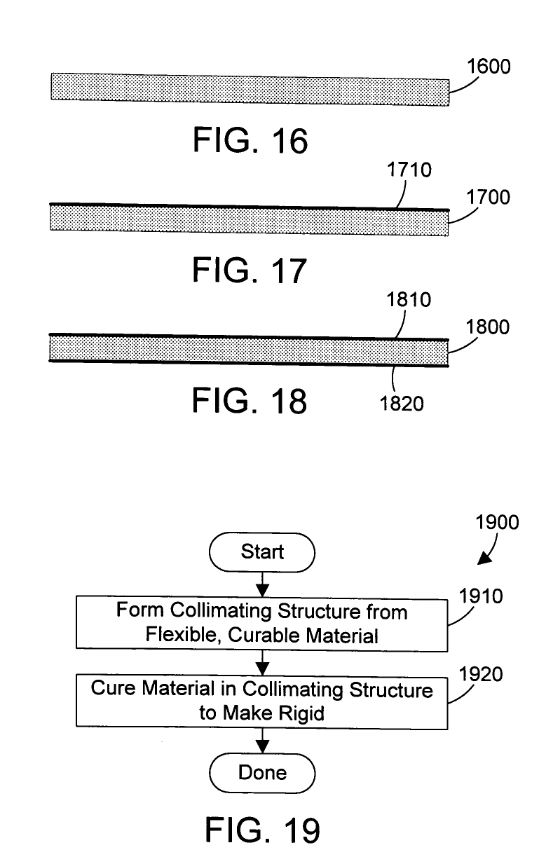

The extended surface of the entry/exit hemispheres of the collimator can be made with none, one, or both ends of the channels closed or covered, or any combination thereof, with either discrete closures or with an overall cladding. FIGS. 16-18 show examples of several of these embodiments. FIG. 16 shows a panel 1600 that has open elongated channels, which means that gases and liquids can pass through the panel 1600. One side may be covered with a light-transmissive cladding material, as shown by cladding layer 1710 overlying the panel 1700 in FIG. 17. Both sides may also be covered with a light-transmissive cladding material, as shown by cladding layers 1810 and 1820 on both sides of panel 1800 in FIG. 18. With both sides closed using sheets of cladding material, as shown in panel 1800 of FIG. 18, then panel 1800 is particularly suitable as a structural member for construction purposes. In this configuration the collimator can be used in an equivalent manner as commercial sheeted-core is used for its strength, light weight, and stiffness for various fabrications. A construction application that might benefit from this embodiment is a wall structure. Exterior walls or windows therein could be made with a collimator panel of the preferred embodiments. When sunlight, skylight, street lights, car lights, or any other light source impinges the wall or window, the collimator can send the light down a hallway and/or conduit where it might otherwise not illuminate. This can be achieved with or without the added use of a light conduit. A similar construction application would use the collimator panel as a light collector/director located on the roof and ceiling. Of course, the foregoing are just examples of construction applications. These examples do not limit the application of the collimator of the preferred embodiments. The preferred embodiments disclosed herein allow any person versed in the art to find numerous uses for the collimator in the practices of construction and fabrication.

Several methods of manufacture are available for this invention. In general, standard manufacturing processes are all candidates for any of the architectures disclosed herein. These standard processes include extrusion, molds with injection or casting, impressing, chemical, light and chemical etching, chemical and mechanical deposition, and photographic techniques. However, it is extremely difficult to make the invention lightweight using the aforementioned standard techniques. Therefore, it is desirable to make the invention lightweight because it will often be mounted overhead, and will often be mounted with existing fixture apparatus that is not amenable to heavy weight. For these and other reasons, the methods of manufacture in accordance with the preferred embodiments include an inventive manufacturing process, which can also be used to manufacture other similar systems.

A method for forming a collimator in accordance with the preferred embodiments is shown as method 1900 in FIG. 19. First, a collimating structure is formed from flexible, curable material (step 1910). The collimating structure is preferably an array of elongated channels, where the area of exit openings is greater than or equal to the area of the entry openings, as shown in FIGS. 2-8 and discussed in detail above. The flexible, curable material is any material that is flexible to allow easily forming the elongated channels, but that is curable by any suitable means to make the structure more rigid. For example, a UV-curable plastic could be used. In the alternative, a curable material could be used that is cured (i.e., made rigid) using a fixating chemical. A thermally curable material could also be used that is cured by exposing the collimator structure to an elevated temperature for a predetermined period of time. Of course, other curable materials could also be used within the scope of the preferred embodiments, which expressly extend to any material that is in a relatively flexible state to allow easily forming the collimator structure, and which can be made more rigid using any suitable method.

The collimating structure is cured to make the collimating structure rigid (step 1920). Note that the term “rigid” is used herein to simply denote that the collimating structure is more rigid after curing than it was before curing, and does not imply a specified level or degree of rigidity. In fact, the collimator of the preferred embodiments could be very lightweight (and easily broken if intentionally misused), yet has sufficient rigidity to hold its shape during normal operation. The result of method 1900 is a collimator structure that is inexpensive to manufacture and strong enough to hold its shape.

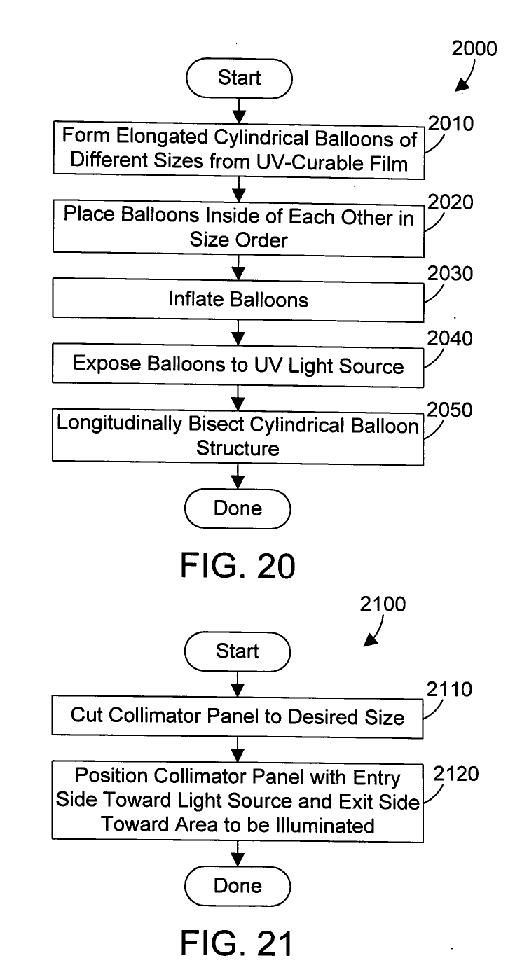

Referring now to FIG. 20, a method 2000 in accordance with a preferred embodiment is a specific method for fabricating an elongated curved collimator 500 for a fluorescent lamp, such as shown in FIGS. 5 and 6. First, elongated cylindrical balloons of different sizes are formed from UV-curable film (step 2010). One suitable UV-curable film is flexible sheets of polymer that have been coated with reflective film on one side. Another suitable UV-curable film is 2-mil thickness UV-curable or chemically curable clear polyester film that has been sputter coated on one side with aluminum. The balloons are then placed inside of each other in size order (step 2020), with the smallest on the inside and the largest on the outside. One or two sides of the nested balloon structure could be attached to a jig to hold the balloons in place. The balloons are then inflated (step 2030), to cause the channel to expand into the shape dictated by the length of the wall film on each side of the channel, and the location of the attachment to the entrance and exit faces, as well as the dictates of the cut shape. However, if all of the channels are inflated simultaneously and to the same pressure, the inner channels might not take proper form because there are not adequate differential pressures across shared walls of abutting channels. Therefore, the channels could be inflated simultaneously in a pressure progression where each inner channel is inflated to a pressure appropriately different than the next outer channel with which it shares a common wall. This results in a progressive pressure distribution that puts every channel into its proper shape. However, the “limp” walls need not all be inflated simultaneously. They can be inflated and made rigid sequentially. For several reasons this might be desirable, including, but not limited to, the avoidance of a need for differential pressuring as discussed above.

Note that a structure of inflatable channels could also be made within the scope of method 2000 by layering different widths of sheet material and pinching off the ends to create an inflatable structure. Using this approach the manufacturing of the collimator can be almost continuous by having several film rolls of different widths feeding along a path which grasps all the side-edges of the films coming off of each roll, leaving the whole film loose and floppy in the center. The pinching process along the edges seals the edges of the film, creating inflatable structures which may be inflated as described above to create the elongated channels.

Once the channels are in their intended configuration, the channels are exposed to UV light from a UV light source (step 2040). The exposure time depends on the specific UV-curable film that is used, but is set to a level that assures curing of the UV-curable film. The UV light causes the thin film to become more rigid, thereby giving the film sufficient structural strength to hold its shape. The UV light sent along the channels can influence the assembly on the sides of the walls that are not covered with reflecting material. That is, in the example at hand, the non-aluminized side of the material within every channel is not protected by the metal, and UV light can enter the UV-curable material in such as manner as to make it rigid. If a chemically curable material were used, then the approach to making the system rigid would use the flow of an appropriately activating gas or other fluid down each of the channels. Of course, there are other ways to activate channel wall materials, including, but not limited to, heat setting, radio-frequency (RF) setting, nuclear setting, and ultrasonic polymerization. Once the channel walls are set, the system can be trimmed, modified, and mounted as suitable to its intended application. For the specific example of the collimator 500 shown in FIGS. 5 and 6, the hardened cylindrical balloon structure may be longitudinally bisected to provide two collimators that have good exit openings for the channels defined by the spaces between concentric cylindrical balloons. Of course, the opposing side that borders the fluorescent bulb will also need to be trimmed to provide good entry openings for the channels next to the bulb. While a similar structure could be manufactured via known mechanical and machining practices, it would be difficult using prior art practices to achieve the desired thinness of the channel walls. These thin channel walls can easily be achieved via the inflation process described above.

Referring now to FIG. 20, a method 2100 is presented for using a collimator panel in accordance with the preferred embodiments. The collimator panel includes a plurality of elongated channels that each have first and second openings, wherein the second opening is larger than the first opening, as shown in FIGS. 2-8. This collimator panel is cut to a desired size (step 2110). The panel is then positioned with the entry side (with the entry openings) toward a light source and the exit side (with the exit openings) toward an area to be illuminated (step 2120). Such a method allows the use of collimator panels as structural panels that also provide the light collimation function described in detail above.

In summary, example applications of the collimator of the preferred embodiments include the enhancement of partially collimated light sources, the collimation of uncollimated light sources, and combinations of both. Example applications of this collimator through enhancement of partially collimated sources include: flashlights, headlamps, spotlights, streetlights, projector lights, retail accent lights, runway lights, displays, and sunlight. The narrowing of beams can be easily enhanced in such examples with relatively thin arrays of elongated channels.

Example applications of the preferred embodiments through the collimation of uncollimated light sources include: fluorescent lamps, frosted bulbs, neon-type lights, ad panels, and skylight. The narrowing of beams in these examples can be accomplished using either of two architectures, shown in FIGS. 3 and 4 and discussed in detail above. Another potential application for the collimator of the preferred embodiments is for use with a UV lamp that is used for germicidal purposes, such as for purification of air or water. In addition, while collimation of an extended light source is discussed herein, the preferred embodiments extend to collimation of both point light sources (e.g., incandescent sources, compact fluorescent light sources, Light-Emitting Diodes (LEDs)) as well as extended light sources.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention. For example, while the preferred embodiments herein refer to the collimation of light, one skilled in the art will recognize that light represents one form of energy that could be collimated (or directed) using the structures and methods of the preferred embodiments. The preferred embodiments also extend to the collimation of any form of energy that can be fully or partially reflected, including radio waves, sound waves, infrared waves, pressure waves, and other forms of energy.

1. A light collimator comprising:
a plurality of elongated reflective channels that each have first and second openings, wherein the second opening is larger than the first opening.

2. The light collimator of claim 1 wherein the first openings of the plurality of elongated channels are disposed towards a light source.

3. The light collimator of claim 1 wherein the second openings of the plurality of elongated channels are disposed towards an area to be illuminated.

4. The light collimator of claim 1 wherein at least one sidewall of at least one of the plurality of elongated channels is substantially straight.

5. The light collimator of claim 1 wherein at least one sidewall of at least one of the plurality of elongated channels is curved.

6. The light collimator of claim 1 wherein the first and second openings have the same geometric shape.

7. The light collimator of claim 1 wherein an area of the light collimator on a side that includes the first openings is substantially equal to an area of the light collimator on the opposite side that includes the second openings.

8. The light collimator of claim 1 wherein an area of the light collimator on a side that includes the first openings is substantially less than an area of the light collimator on the opposite side that includes the second openings.

9. The light collimator of claim 1 wherein the plurality of elongated channels allow flow of fluid and gas through the plurality of elongated channels.

10. The light collimator of claim 1 further comprising a first cladding layer overlying the first openings of the collimator, wherein the first cladding layer is substantially transmissive to light.

11. The light collimator of claim 10 further comprising a second cladding layer overlying the second openings of the collimator, wherein the second cladding layer is substantially transmissive to light.

12. The light collimator of claim 1 wherein the elongated channels are formed of a thin material.

13. The light collimator of claim 1 wherein the elongated channels are formed from a substantially solid material.

14. The light collimator of claim 1 wherein the elongated channels have an internal reflectance of at least 50%, with a specular reflectance cone angle of no more than 45 degrees containing at least 80% of a specular reflected light component.

15. The light collimator of claim 1 wherein the elongated channels have an internal reflectance of at least 85%, with a specular reflectance cone angle of no more than 10 degrees containing at least 80% of a specular reflected light component.

16. The light collimator of claim 1 wherein the elongated channels have an internal reflectance of at least 95%, with a specular reflectance cone angle of no more than 5 degrees containing at least 80% of a specular reflected light component.

17. A light collimator for a fluorescent bulb, the light collimator comprising:
a curved structure of elongated channels that each have first and second openings, wherein each second opening for a channel is larger than the corresponding first opening for the channel, wherein the first openings are arranged to lie along an arc of a circle defined by a size of the fluorescent bulb, the second ends of the elongated channels being located in substantially the same plane.

18. The light collimator of claim 17 wherein the plane of the second ends of the elongated channels is substantially parallel to a plane that is tangent to the arc of the circle.

19. A structural panel that collimates light, the structural panel comprising:
a plurality of elongated channels that each have first and second openings, wherein the second opening is larger than the first opening, the first openings lying in a first plane and the second openings lying in a second plane.

20. The structural panel of claim 19 wherein the first and second planes are substantially parallel.

21. The structural panel of claim 19 further comprising a first cladding layer overlying the first openings of the collimator, wherein the first cladding layer is substantially transmissive to light.

22. The structural panel of claim 21 further comprising a second cladding layer overlying the second openings of the collimator, wherein the second cladding layer is substantially transmissive to light.

23. A method for collimating light, the method comprising the steps of:
providing a collimator panel that comprises a plurality of elongated channels that each have first and second openings, wherein the second openings are larger than the corresponding first openings;
positioning the first openings in the collimator panel towards a light source; and
positioning the second openings in the collimator panel towards an area to be illuminated.

24. The method of claim 23 wherein at least one sidewall of at least one of the plurality of elongated channels is substantially straight.

25. The method of claim 23 wherein at least one sidewall of at least one of the plurality of elongated channels is curved.

26. The method of claim 23 wherein the first and second openings have the same geometric shape.

27. The method of claim 23 wherein the plurality of elongated channels each have a reflective surface.

28. The method of claim 23 wherein the plurality of elongated channels allow flow of fluid and gas through the plurality of elongated channels.

29. A method for manufacturing a light collimator, the method comprising the steps of:
(A) forming from curable material a structure comprising a plurality of elongated reflective channels that each have first and second openings, wherein the second opening is larger than the first opening; and
(B) exposing the structure to a curing process.

30. The method of claim 29 wherein the curable material comprises a thin polymer sheet.

31. The method of claim 30 wherein step (A) is performed by shaping the thin polymer sheet to form the plurality of elongated channels.

32. The method of claim 29 wherein step (A) is performed by injection-molding the curable material into a mold that defines the structure.

33. The method of claim 29 wherein the curable material comprises light-curable material, and wherein the curing process comprises exposing the light-curable material to a light source.

34. The method of claim 29 wherein the curable material comprises chemically-curable material, and wherein the curing process comprises exposing the chemically-curable material to a curing chemical.

35. The method of claim 29 wherein the curable material comprises thermally-curable material, and wherein the curing process comprises exposing the thermally-curable material to a specified temperature.

36. A method for manufacturing a light collimator for an extended light source, the method comprising the steps of:
forming a plurality of elongated cylindrical balloons of different sizes from curable film;
placing the plurality of balloons inside of each other in size order to form a cylindrical balloon structure;
inflating the plurality of balloons; and
curing the plurality of balloons.

37. The method of claim 36 further comprising the step of:
longitudinally bisecting the cylindrical balloon structure.

38. The method of claim 36 wherein the curable film comprises light-curable film, and wherein the step of curing the plurality of balloons comprises the step of exposing the plurality of balloons to a light source.

39. The method of claim 36 wherein the curable film comprises chemically-curable film, and wherein the step of curing the plurality of balloons comprises the step of exposing the plurality of balloons to a curing chemical.

40. The method of claim 36 wherein the curable film comprises thermally-curable film, and wherein the step of curing the plurality of balloons comprises the step of exposing the plurality of balloons to a specified temperature.

41. A method for manufacturing a light collimator for an extended light source, the method comprising the steps of:
forming a balloon structure of a plurality of elongated inflatable chambers from curable film;
inflating the plurality of inflatable chambers in the balloon structure; and
curing the plurality of inflatable chambers in the balloon structure.

42. The method of claim 41 further comprising the step of:
longitudinally bisecting the balloon structure.

43. The method of claim 41 wherein the curable film comprises light-curable film, and wherein the step of curing the plurality of inflatable chambers in the balloon structure comprises exposing the plurality of inflatable chambers to a light source.

44. The method of claim 41 wherein the curable material comprises chemically-curable material, and wherein the step of curing the plurality of inflatable chambers in the balloon structure comprises exposing the plurality of inflatable chambers to a curing chemical.

45. The method of claim 41 wherein the curable material comprises thermally-curable material, and wherein the step of curing the plurality of inflatable chambers in the balloon structure comprises exposing the plurality of inflatable chambers to a specified temperature.
